(19) United States
(12) Patent Application Publication
(10) Pub. No.: US 2012/0241023 A1
(43) Pub. Date: Sep. 27, 2012

(54) CONTROL VALVE DEVICE

(75) Inventors: Nobukazu Ikeda, Osaka (JP); Michio Yamaji, Osaka (JP); Tsuyoshi Tanikawa, Osaka (JP); Hiroshi Kaneko, Sendai (JP); Yasushi Yagi, Sendai (JP); Yuji Ono, Sendai (JP); Tadahiro Ohmi, Sendai (JP); Yasuyuki Shirai, Sendai (JP)

(73) Assignees: Fujikin Incorporated, Osaka-shi, Osaka (JP); Tohoku University, Sendai-shi, Miyagi (JP); Tokyo Electron Limited, Tokyo (JP)

(21) Appl. No.: 13/508,448

(22) PCT Filed: Oct. 29, 2010
(86) PCT No.: PCT/JP2010/069262

§ 371 Date: Jun. 13, 2012

(30) Foreign Application Priority Data
Nov. 9, 2009 (JP) 2009-256210

(51) Int. Cl. F16K 31/128; F16K 1/34

(52) U.S. Cl. 137/487; 251/61.1; 251/333

(57) ABSTRACT

A control valve device develops opening/closing accuracy of a valve assembly. The valve head 310a is configured to open and close a transfer path formed in the valve housing 305 by transmitting the power to the valve assembly 310 from the power transmission member according to a pressure ratio between working fluid supplied to the first space Us and the second space Ls, respectively. The valve head has a Vickers hardness larger than a Vickers hardness of a valve seat of the transfer path to be in contact with the valve head, and a hardness difference therebetween is set to be about 200 Hv to about 300 Hv.

### TECHNICAL FIELD

The present disclosure relates to a control valve device for opening and closing a valve assembly by a gas.

### BACKGROUND ART

In a manufacturing apparatus for performing a required process on a processing target object by using a gas, a transfer path for transferring the gas into a processing chamber is formed, and a control valve for opening/closing the transfer path and controlling a flow rate of the gas may be provided in the transfer path. By way of example, in a control valve device described in Patent Document 1, an opening/closing valve and a flow rate control valve are provided on a same axis line between an In-port and an Out-port of a valve. The opening/closing valve and the flow rate control valve are arranged in series, and an operation device for the opening/closing valve and an operation device for the flow rate control valve are separately provided. When the opening/closing valve is opened, the flow rate control valve is switched between a throttle position and an opening position while varying a flow rate of the gas continuously.

Patent Document 1: Japanese Patent Laid-open Publication No. H11-153235

### DISCLOSURE OF THE INVENTION

### [Problems to Be Solved by the Invention]

However, when a valve assembly is opened and closed, leakage may occur at an opening/closing portion of the valve assembly due to mechanical interference between the valve assembly and a valve seat in contact with the valve assembly or due to slight deviation between the valve assembly and the valve seat that may occur during the assembly of the valve. Especially, if the valve assembly is repeatedly contacted with the valve seat, galling or adhesion may occur, resulting in great leakage. By way of example, in an organic EL device, a film forming material (organic molecules) evaporated from a deposition source is transferred to a substrate after passing through a transfer path while being carried by a carrier gas. In order to prevent the film forming material from adhering to an inner wall of the transfer path during the transfer, the transfer path is set to be in a high temperature state of, e.g., about 300° C. or higher in consideration of an adhesion coefficient. In this state, if the opening/closing operation of the valve assembly is repeated, friction between the valve assembly and the valve seat may occur due to mechanical interference therebetween, and, besides, the components of the valve assembly and the valve seat may be melted due to thermal influence. As a result, galling or sticking may occur, and opening/closing accuracy of the valve assembly may be degraded. Consequently, it may become difficult to control the gas.

To solve the foregoing problems, the present disclosure provides a control valve device having improved opening/closing accuracy of the valve assembly by optimizing structures of a valve assembly and a valve seat in contact with the valve assembly.

### [Means for Solving the Problems]

In accordance with one aspect of an illustrative embodiment, there is provided a control valve device including a valve assembly having a valve head; a power transmission member that is connected to the valve assembly and transmits a power to the valve assembly; a valve housing for accommodating therein the valve assembly and allowing the valve assembly to be slidable therein; a first bellows whose one end is fastened to the power transmission member and the other end is fastened to the valve housing, the first bellows forming a first space at a position opposite to the valve assembly with respect to the power transmission member; a second bellows whose one end is fastened to the power transmission member and the other end is fastened to the valve housing, the second bellows forming a second space at a position at a side of the valve assembly with respect to the power transmission member, the second space being isolated from the first space by the first bellows; a first pipe communicating with the first space; and a second pipe communicating with the second space. The valve head is configured to open and close a transfer path formed in the valve housing by transmitting the power to the valve assembly from the power transmission member according to a pressure ratio between working fluid supplied to the first space and the second space via the first pipe and the second pipe, respectively. Further, the valve head has a Vickers hardness larger than a Vickers hardness of a valve seat of the transfer path to be in contact with the valve head, and a hardness difference therebetween is set to be about 200 Hv to about 300 Hv.

As shown in FIG. 1, by using the first bellows 320b, the first space Us is formed at a position opposite to the valve assembly 310 with respect to the power transmission member 320a. By using the first bellows 320b and the second bellows 320c, the second space Ls is formed at a position at the side of the valve assembly 310 with respect to the power transmission member 320a. According to a ratio between a gas supplied into the first space Us and a gas supplied into the second space Ls, the power transmission member 320a provided between the first space and the second space can be slid in a direction for closing the valve assembly or in a direction for opening the valve assembly. This power is transmitted to the valve head 310a via the valve shaft 310c. Accordingly, by bringing the valve head 310a into contact with a valve seat 200a3 of the transfer path or by separating them, an operation for opening/closing the transfer path can be controlled.

Especially, a Vickers hardness of the valve head is larger than a Vickers hardness of the valve seat, and a hardness difference therebetween is about 200 Hv to about 300 Hv. If there is no hardness difference between the valve head and the valve seat or if the hardness difference therebetween is very small, a sliding effect may not occur. As a result, a failure in properly fitting the valve assembly to the valve seat, for example may be generated. Meanwhile, if the hardness difference between the valve head and the valve seat is too large, a portion of the valve seat in contact with the valve head may be damaged, resulting in an increase of a leakage amount. In accordance with the illustrative embodiment, by setting the Vickers hardness of the valve head to be larger than the Vickers hardness of the valve seat by about 200 Hv to about 300 Hv, the valve head may be properly fitted to the valve seat after the valve assembly is opened and closed about 20 thousand times as a result of repeated contact between the valve head and the valve seat. As a consequence, a leakage mount can be reduced. Accordingly, durability of the control valve device can be improved, and, thus, lifetime of the control valve device can be lengthened.

The Vickers hardness of the valve seat may be set to be about 400 Hv to about 500 Hv.

The valve seat is a surface of a metal, to which stellite is attached, on a base.

The valve head may be plated with a Ni-based alloy.

A portion of the valve head that is contacted with the transfer path may have a tapered shape, and a taper angle to a component perpendicular to a leading end surface of the valve head may range from about 40° to about 80°.

The portion of the valve head that is contacted with the transfer path may have a circular arc shape having a radius of curvature.

The valve seat may have a tapered shape or a circular arc shape.

The control valve device may be used at a temperature ranging from about 25° C. to about 500° C.

An inert gas may be supplied into the first and second spaces as the working fluid.

A liquid may be supplied into the first and second spaces as the working fluid.

An operating pressure for the control valve device may range from about 0.2 MPa to about 0.6 MPa.

The control valve device may be used in opening and closing the transfer path configured to transfer organic molecules for forming a film on a processing target object up to a vicinity of the processing target object.

### [Effect of the Invention]

In accordance with an illustrative embodiment, by optimizing the structures of a valve assembly and a valve seat in contact with the valve assembly, opening/closing accuracy of the valve assembly can be improved.

### BRIEF DESCRIPTION OF THE DRAWINGS

FIG. 1 is a cross sectional view illustrating a control valve device in accordance with an illustrative embodiment.

FIG. 2A is a chart showing an initial leakage amount of the control valve device in accordance with the illustrative embodiment.

FIG. 2B provides a comparative example for FIG. 2A.

FIG. 3A is a graph showing a relationship between a leakage amount and the number of usage of the control valve device in accordance with the illustrative embodiment.

FIG. 3B provides a comparative example for FIG. 3A.

FIG. 4 is a schematic perspective view illustrating a six-layer consecutive film forming apparatus in accordance with the illustrative embodiment.

FIG. 5 is a cross sectional view of a film forming device in accordance with the illustrative embodiment.

FIG. 6 is a cross sectional view illustrating a deposition source and a transfer path in accordance with the illustrative embodiment.

FIG. 7 is a diagram schematically illustrating an organic EL device formed by the six-layer consecutive film forming apparatus in accordance with the illustrative embodiment.

### MODE FOR CARRYING OUT THE INVENTION

Hereinafter, a control valve device in accordance with an illustrative embodiment will be described with reference to the accompanying drawings. Through the whole document, parts having same configurations and functions will be assigned same reference numerals, and redundant description will be omitted.

[Control Valve Device]

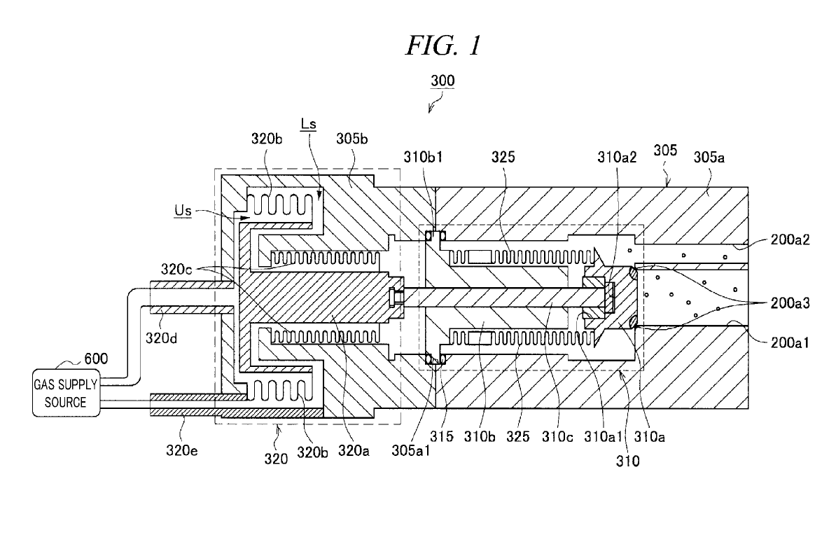

First, referring to FIG. 1 that provides a cross sectional view of a control valve device 300, an internal configuration and an operation of the control valve device 300 will be described. The control valve device 300 includes a cylindrical valve housing 305. The valve housing 305 is divided into two sections: a front section 305a and a rear section 305b. The valve housing 305 is hollow, and a valve assembly 310 indicated by a dashed line is accommodated in a substantially central portion of the valve housing 305. The rear section 305b of the valve housing incorporates therein a valve driving unit 320 as indicated by a dashed line on a rear side.

The valve assembly 310 includes a valve head 310a and a valve body 310b. The valve head 310a and the valve body 310b are connected with each other by a valve shaft 310c. To elaborate, the valve shaft 310c is a rod-shaped member and is fitted into a recess 310a1 formed at the center of the valve head 310a through the center of the valve body 310b in a lengthwise direction. A protrusion 310b1 provided at the rear side portion of the valve body 310b is inserted in a recess 305a1 formed at the front section 305a of the valve housing 305. An outgoing path 200a1 and an incoming path 200a2 for transferring a gas are formed in the front section 305a of the valve housing 305.

The recess 305a1 has a space for allowing the valve body 310b to be slidable therein in a lengthwise direction with the protrusion 310b1 inserted in the recess 305a1. In that space, a heat-resistant seal member 315 is disposed. A metal gasket may be one example of the seal member 315. The seal member 315 isolates a vacuum at a side of the transfer path from an atmosphere at the side of the valve driving unit 320. Further, the seal member 315 also serves to alleviate mechanical interference between the protrusion 310b1 and the front section 305a of the valve housing when the valve body 310b slides.

(Separation Structure of the Valve Body and the Valve Head)

The recess 310a1 of the valve head 310a also has a clearance 310a2 with the valve shaft 310c inserted therein. In accordance with the valve assembly 310 of the illustrative embodiment, the valve body 310b and the valve head 310a are separately provided. With this configuration, a clearance (gap) between the valve body 310b and the valve shaft 310c can be controlled. Accordingly, it is possible to compensate a deviation of a center position of the valve assembly 310 when the valve assembly is opened and closed. In addition, by forming the clearance 310a2 in the recess 310a1 of the valve head 310a, a minute difference in the axis of the valve head 310a can be adjusted. Accordingly, the valve head 310a having a tapered shape can be brought into contact with the valve seat 200a3 having the tapered shape without being deviated. Here, the valve seat 200a3 is a sheet member attached to a base that forms a transfer path. The valve head 310a comes into contact with the valve seat 200a3.

The valve driving unit 320 includes a power transmission member 320a; a first bellows 320b; and a second bellows 320c, which are accommodated in the valve housing 305. The power transmission member 320a has a substantially T-shape and is fastened to an end portion of the valve shaft 310c by a screw.

One end of the first bellows 320b is welded to the power transmission member 320a, and the other end of the first bellows 320b is welded to the rear section 305b of the valve housing. With this arrangement, a first space Us isolated by the power transmission member 320a, the first bellows 320b and the rear section 305b is formed at a position opposite to the valve assembly 310 with respect to the power transmission member 320a.

One end of the second bellows 320c is welded to the power transmission member 320a, and the other end of the second bellows 320c is welded to the rear section 305b of the valve housing. With this arrangement, a second space Ls isolated by the power transmission member 320a, the first bellows 320b, the second bellows 320c and the rear section 305b is formed at a position at a side of the valve assembly with respect to the power transmission member 320a.

An inside of a first pipe 320d communicates with the first space Us. The first pipe 320d supplies an inert gas such as an argon gas or a nitrogen gas from a gas supply source 600 into the first space Us. An inside of a second pipe 320e communicates with the second space Ls. The second pipe 320e supplies an inert gas such as an argon gas or a nitrogen gas from the gas supply source 600 into the second space Ls. With this configuration, the respective spaces are airtightly sealed by elasticity of the bellows, and the inert gas can be introduced into the respective spaces. Further, instead of the inert gas, a liquid such as galden or ethylene glycol may be supplied into the first space Us and the second space Ls. That is, by supplying a working fluid such as a gas or a liquid into the first space Us and the second space Ls, a pressure ratio between the spaces can be controlled.

To elaborate, by adjusting a ratio between the inert gas supplied into the first space Us and the inert gas supplied into the second space Ls, the power transmission member 320a can be moved in a forward direction or in a backward direction. By way of example, if the pressure within the first space Us becomes relatively higher than the pressure within the second space Ls by the gases supplied into the first space Us and into the second space Ls, the power transmission member 320a presses the valve shaft 310c forward. As a result, the valve head 310a is moved forward and come into contact with the valve seat 200a3, and the valve becomes closed. Further, by way of example, if the pressure within the first space Us becomes relatively lower than the pressure within the second space Ls by the gases supplied into the first and second spaces, the power transmission member 320a pulls the valve shaft 310c backward. As a result, the valve head 310a is moved backward away from the valve seat 200a3, and the valve becomes opened.

One end of a third bellows 325 is welded to the valve head 310a, and the other end of the third bellows 325 is welded to the valve body 310b. With this third bellows 325, an atmosphere space at a side of the valve shaft and a vacuum space at the side of the transfer path are isolated. Further, by supporting the gap between the valve body 310b and the valve head 310a with the bellows 325, it is possible to control the clearance between the valve body 310b and the valve shaft 310c. With this configuration, when the valve assembly is opened and closed, generation of friction between the valve assembly 310 and the valve shaft 310c due to contact therebetween can be prevented.

(Material and Surface Treatment for the Valve Assembly and the Valve Seat)

In the control valve device 300 having the above-described configuration, in order to minimize a leakage amount, materials, shapes and surface processing of the valve assembly and the valve seat need to be optimized. By way of example, the present inventors have employed austenite-based stainless steel (SUS316L) having high heat resistance property as a material for the valve assembly 310. Further, the present inventors have also processed F2 coat (registered trademark) on a surface of the valve assembly 310. The F2 coat refers to a treatment for coating stainless steel with a material prepared by mixing phosphorus into nickel. In accordance with the illustrative embodiment, the valve head is plated with a Ni-based alloy as the F2 coat. Especially, through this treatment, the inventors have set a Vickers hardness of the valve head to about 600 Hv to about 700 Hv.

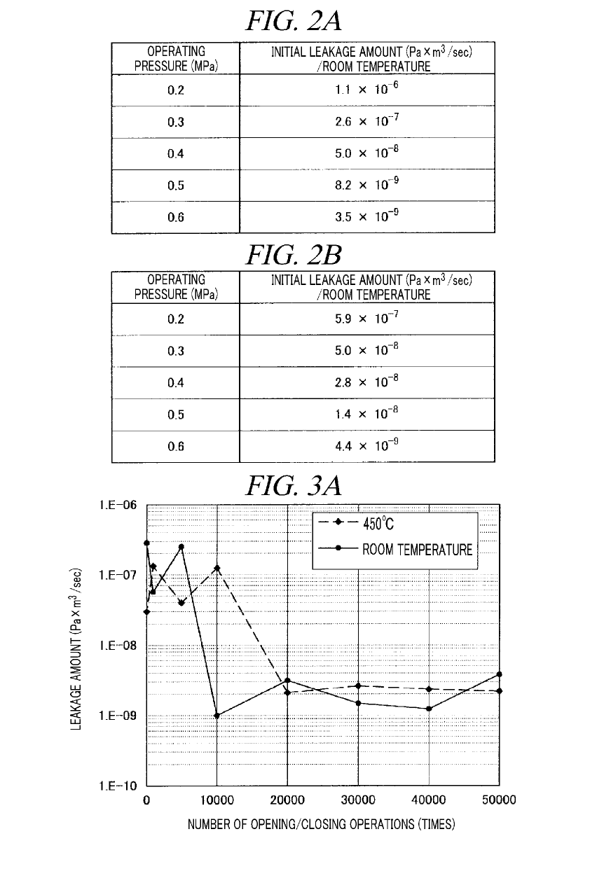

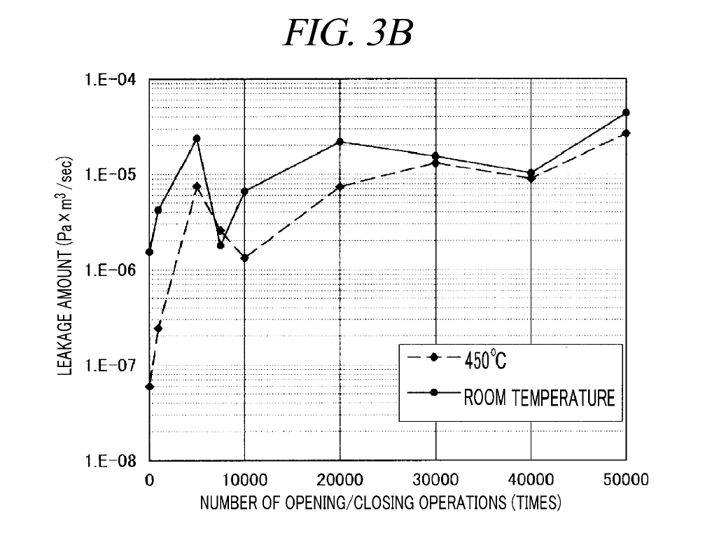

For the valve seat 200a3, stellite that is prepared by performing welding of a cobalt alloy on stainless steel is employed, and a surface of a metal to which the stellite is attached is polished with super high precision. Accordingly, a Vickers hardness of the valve seat 200a3 is set to be about 410 Hv to about 440 Hv. As a result, a good opening/closing operation of the valve assembly 310 is achieved, and the leakage amount is reduced, leading to improvement of durability and increase of lifetime of the control valve device. These effects will be described below with reference to FIGS. 2A to 3B.

[Investigation of Leakage State]

The present inventors have investigated a leakage state of the valve assembly 310 by using the control valve device 300 having the above-described configuration. For comparison, a following valve assembly is used as a comparative example. Austenite-based stainless steel (SUS316L) is used as a material for the valve assembly and a valve seat in accordance with a comparative example, and F2 coat (registered trademark) is processed on a surface of the valve assembly and a burnishing process is performed on the valve seat. The burnishing process is a process for hardening a surface layer of an object through plastic deformation by pressing the surface of the object by a roller and polishing a surface of the object with super high precision, thus making the surface similar to a mirror surface. Through these processes, in the comparative example, a Vickers hardness of a valve head 310a is set to be about 600 Hv to about 700 Hv, and a Vickers hardness of the valve seat is set to be about 300 Hv. A hardness difference between the valve head and the valve seat is about 300 Hv to about 400 Hv. Further, in accordance with the comparative example, the valve assembly is formed as a single body type in which the valve head and a valve body are not separated.

First, an initial leakage amount is measured at a room temperature (about 25° C.). Conditions for the experiment are as follows.

Operating pressure: about 0.2 MPa to about 0.6 MPa

Supplied gas: nitrogen gas

In opening/closing the valve assembly:
Perform vacuum exhaust of valve inlet side
Perform gas pressurization of valve outlet side

(Initial Leakage Amount)

As a result of the experiment, FIG. 2A is a chart showing the initial leakage amount of the control valve device 300 in accordance with the illustrative embodiment, and FIG. 2B provides a result of the comparative example. In the control valve device 300, the initial leakage amount is found to be in the range of, e.g., about 10⁻⁶ Pa×m³/sec to about 10⁻⁹ Pa×m³/sec. Meanwhile, in case of the comparative example, the initial leakage amount is found to be in the range of about 10⁻⁷ Pa×m³/sec to about 10⁻⁹ Pa×m³/sec, smaller than the initial leakage amount of the control valve device 300 in accordance with the illustrative embodiment in overall.

(Number of Opening/Closing Operations and Leakage Amount)

Now, a result of investigating a relationship between the number of opening/closing operations and the leakage amount will be explained. Experiments shown in FIGS. 3A and 3B are performed at a room temperature and a temperature of about 450° C., respectively, under the condition that an operating pressure is set to be about 0.3 MPa in both cases. FIG. 3A is a graph showing the relationship between the number of opening/closing operations and the leakage amount in accordance with the illustrative embodiment, and FIG. 3B provides a comparative example therefor.

According to the experiment result, in the control valve device 300 in accordance with the illustrative embodiment, in both of the room temperature and the temperature of about 450° C., the leakage amount is found to be in the range of about 10⁻⁹ Pa×m³/sec when the number of opening/closing operations ranges from about 20 thousands to about 50 thousands. Especially, when the number of opening/closing operations ranges up to about 40 thousands after reaching 20 thousands, the leakage amount in the range of about 10⁻⁹ Pa×m³/sec is maintained stably with a little variation in the state thereof. As compared to a leakage amount in the range of about 10⁻⁸ Pa×m³/sec to about 10⁻⁷ Pa×m³/sec before the number of opening/closing operations reaches about 10 thousands, it is deemed that when the number of opening/closing operations reaches about 20 thousands, the valve head may be properly fitted to the valve seat, resulting in reduction of the leakage amount.

Meanwhile, in case of the comparative example, in both of the room temperature and the temperature of about 450° C., the leakage amount is found to be increased with the rise of the number of opening/closing operations. If the number of opening/closing operations exceeds about 20 thousands, the leakage amount is in the range of about 10⁻⁵ Pa×m³/sec.

From the above experiments, it is found out that if the hardness difference between the valve head and the valve seat is in the range of about 300 Hv to about 400 Hv, the valve seat may be damaged as the number of opening/closing operations increases, resulting in the increase of the leakage amount.

Meanwhile, in accordance with the illustrative embodiment, by processing the F2 coat on the valve head 310a, the Vickers hardness of the valve head is set to be equal to or larger than about 600 Hv (ranging from, e.g., about 600 Hv to about 700 Hv), and the Vickers hardness of the valve seat 200a3 is set to be equal to or larger than about 400 Hv (ranging from, e.g., about 400 Hv to about 500 Hv). In this way, the Vickers hardness of the valve head 310a is set to be larger than the Vickers hardness of the valve seat 200a3, and a hardness difference therebetween is set to be in the range from, e.g., about 200 Hv to about 300 Hv. Further, the different surface hardening processes are performed on the valve head 310a and the valve seat 200a3, respectively. As a result, when the number of opening/closing operations reaches about 20 thousands, the valve head may be fitted to the valve seat. Hence, the leakage amount can be reduced and it may be possible to manufacture the control valve device 300 having improved durability and lifetime.

[Six-Layer Consecutive Film Forming Apparatus]

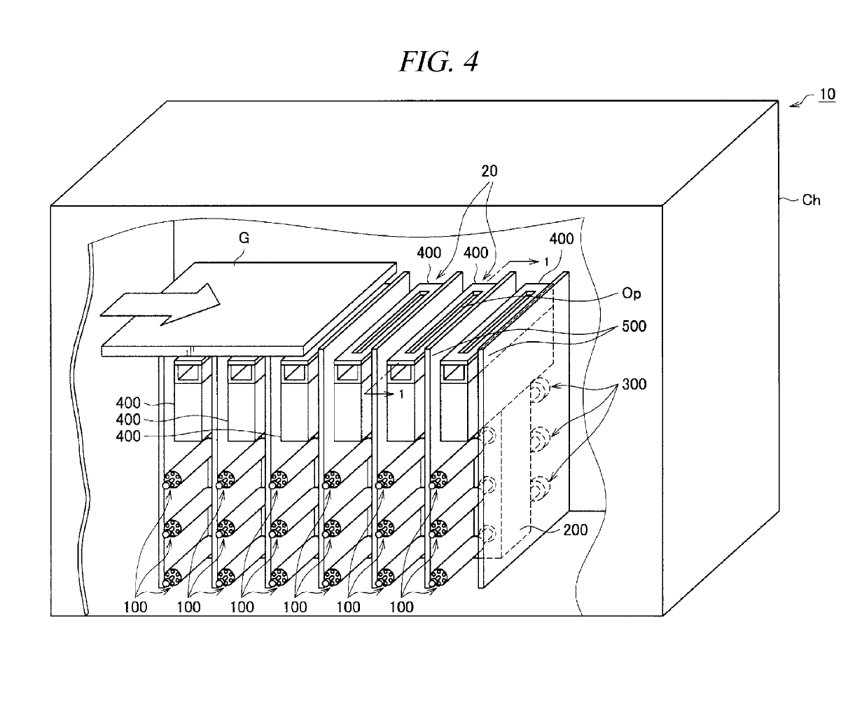

Now, a six-layer consecutive film forming apparatus using the control valve device 300 as described above will be explained with reference to FIG. 4. The six-layer consecutive film forming apparatus 10 includes six film forming units 20 within a vacuum chamber Ch maintained in a required vacuum state. Each of the film forming units 20 includes three deposition source units 100; a connection pipe 200; three control valve devices 300; and a blowing device 400. The three control valve devices 300 make pairs with the three deposition source units 100, respectively, and are disposed opposite to the deposition source units 100 with the connection pipe 200 therebetween. Partition plates 500 are provided between the respective film forming units 20.

Each of the deposition source unit 100 is made of a metal such as SUS. For example, since quartz hardly reacts with an organic material, the deposition source unit 100 may be made of a metal coated with quartz or the like. The deposition source unit 100 is an example of a deposition source that vaporizes a material, and it need not be a unit-type deposition source but may be a general crucible.

Different kinds of organic materials are stored in the deposition source units 100. The deposition source units 100 are kept at required temperatures to vaporize the organic materials stored therein. Here, the term “vaporization” implies not only a phenomenon that a liquid is converted to a gas but also a phenomenon that a solid is directly converted to the gas without becoming the liquid (i.e., sublimation). Vaporized organic molecules are transported into the blowing device 400 through the connection pipe 200 and are blown out from a slit-shaped opening Op formed at the top of the blowing device 400. The blown organic molecules adhere to a substrate G, and, thus, a film is formed on the substrate G. The partition plates 500 prevent organic molecules blown out from adjacent openings Op from being mixed. Further, in accordance with the illustrative embodiment, as shown in FIG. 4, although a film is formed on the substrate G that is slid at a ceiling position of the vacuum chamber Ch while facing downward, the substrate G may be positioned in a face-up state.

[Film Forming Unit]

An internal configuration of the film forming unit 20 will be explained with reference to FIG. 5 that provides a cross sectional view taken along a line 1-1 of FIG. 4. The deposition source unit 100 includes a material input device 110 and an external case 120. The material input device 110 has a material receptacle 110a for storing therein an organic film forming material and a flow path 110b for introducing a carrier gas. The external case 120 is formed to have a bottle shape. The material input device 110 is detachably mounted in the hollow inside of the external case. If the material input device 110 is mounted in the external case 120, an internal space of the deposition source unit 100 is determined, and this internal space communicates with a transfer path 200a formed within the connection pipe 200. The transfer path 200a is opened and closed by the aforementioned operation of the control valve device 300.

An argon gas is introduced into the flow path 110b from an end of the material input device 110. The argon gas functions as the carrier gas for transferring organic materials of the film forming material stored in the material receptacle 110a. The carrier gas may not be limited to the argon gas, but any inert gas such as a helium gas or a krypton gas may be used. The organic molecules of the film forming material are transferred from the deposition source unit 100 to the blowing device 400 through the transfer path 200a of the connection pipe 200. Then, after temporarily staying in a buffer space S, the organic molecules of the film forming material are blown out through the slit-shaped opening Op and adhere to the substrate G.

[Route of Transfer Path]

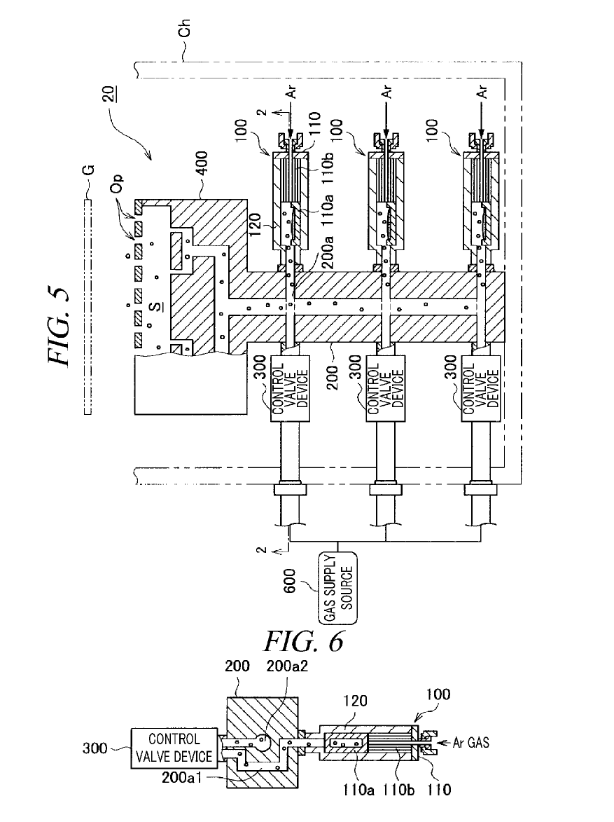

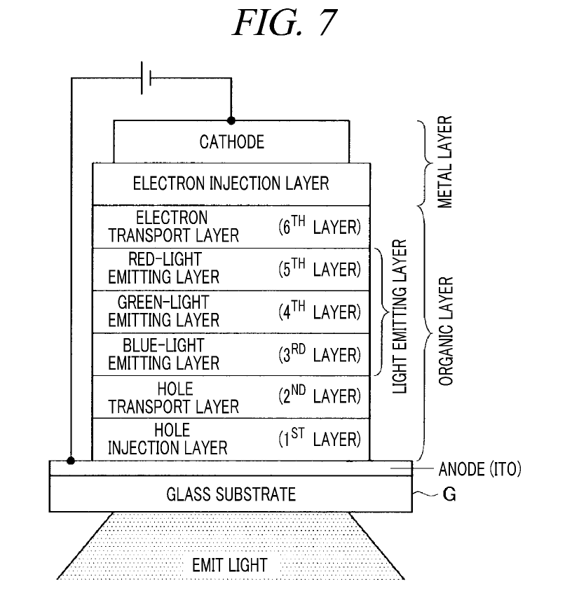

Now, the route of the transfer path 200a will be briefly explained with reference to FIG. 6 that provides a cross sectional view taken along a line 2-2 of FIG. 5. As stated above, the connection pipe 200 transports the vaporized organic molecules toward the blowing device 400 via the control valve device 300. To elaborate, since the valve assembly of the control valve device 300 is opened during a film forming process, the organic molecules vaporized from the respective deposition source units 100 are transferred by the carrier gas. Further, the organic molecules are transferred toward the blowing device 400 from the outgoing path 200a1 of the transfer path via the incoming path 200a2 of the transfer path. Meanwhile, since the valve assembly of the control valve device 300 is closed when the film forming process is not performed, the outgoing path 200a1 and the incoming path 200a2 are closed, and the transportation of the organic molecules is stopped.

[Organic Film Structure]

In the six-layer consecutive film forming apparatus 10 having the above-described configuration, the substrate G is moved above a first blowing device 400 to a sixth blowing device 400 at a certain moving speed. While the substrate G is being moved, as shown in FIG. 4, a hole injection layer as a first layer, a hole transport layer as a second layer, a blue-light emitting layer as a third layer, a green-light emitting layer as a fourth layer, a red-light emitting layer as a fifth layer and an electron transport layer as a sixth layer are formed on an ITO of the substrate G in this sequence from the bottom. In this way, in accordance with the six-layer consecutive film forming apparatus 10 of the illustrative embodiment, the first to the sixth organic layers are formed consecutively. Among these layers, the blue-light emitting layer, the green-light emitting layer and the red-light emitting layer as the third to the fifth layers emit light by the recombination of holes and electrons. Further, metal layers (an electron injection layer and a cathode) on the organic layers are formed by sputtering.

Through these processes, an organic EL device having the organic layers sandwiched between a positive pole (anode) and a negative pole (cathode) is formed on the glass substrate. If a voltage is applied to the anode and the cathode of the organic EL device, holes are injected into the organic layers from the anode, while electrons are injected into the organic layers from the cathode. The injected holes and electrons are recombined in the organic layers. At the moment, light is emitted.

While various aspects and embodiments have been described herein with reference to the accompanying drawings, other aspects and embodiments will be apparent to those skilled in the art. The various aspects and embodiments disclosed herein are for the purposes of illustration and are not intended to be limiting. Therefore, the true scope and spirit of the invention is indicated by the appended claims rather than by the foregoing description, and it shall be understood that all modifications and embodiments conceived from the meaning and scope of the claims and their equivalents are included in the scope of the invention.

By way of example, the control valve device in accordance with the illustrative embodiment may be used to open and close a transfer path for transferring organic molecules for forming a film on a processing target object up to a vicinity of the processing target object. Further, the control valve device in accordance with the illustrative embodiment may be applicable to not only the organic EL device but also various manufacturing apparatuses such as a semiconductor manufacturing apparatus and a FPD apparatus. Especially, the control valve device in accordance with the illustrative embodiment may be used in an environment in which the temperature ranges from, e.g., about 25° C. to about 500° C. with the operating pressure ranging from, e.g., about 0.2 MPa to about 0.6 MPa.

The portion of the valve head that is contacted with the transfer path may have a circular arc shape, without being limited to the tapered shape. Likewise, the shape of the valve seat is not limited to the tapered shape but the valve seat may have the circular arc shape.

When the portion of the valve head that is contacted with the transfer path has the tapered shape, a taper angle θ to a component perpendicular to a leading end surface of the valve head may range from, e.g., about 40° to about 80° . When the portion of the valve head that is contacted with the transfer path has the circular arc shape, a radius of curvature may be employed.

In addition, an organic material in the form of powder (solid) may be used as a film forming material for the organic EL device in accordance with the illustrative embodiment. Further, the illustrative embodiment may be applied to a MOCVD (Metal Organic Chemical Vapor Deposition) in which a liquid organic metal is mainly used as the film forming material and a thin film grows on a processing target object by decomposing a vaporized film forming material on the heated processing target object.

[Explanation of Codes]
10: Six-layer consecutive film forming apparatus
20: Film forming unit
100: Deposition source unit
200: Connection pipe
200a: Transfer path
200a1: Outgoing path
200a2: Incoming path
300: Control valve device
305: Valve housing
305a: Front section of valve housing
305b: Rear section of valve housing
310: Valve assembly
310a: Valve head
310b: Valve body
310c: Valve shaft
315: Seal member
320: Valve driving unit
320a: Power transmission member
320b: First bellows
320c: Second bellows
320d: First pipe
320e: Second pipe
400: Blowing device
600: Gas supply source

1. A control valve device comprising:
a valve assembly having a valve head;
a power transmission member that is connected to the valve assembly and transmits a power to the valve assembly;
a valve housing for accommodating therein the valve assembly and allowing the valve assembly to be slidable therein;
a first bellows whose one end is fastened to the power transmission member and the other end is fastened to the valve housing, the first bellows forming a first space at a position opposite to the valve assembly with respect to the power transmission member;
a second bellows whose one end is fastened to the power transmission member and the other end is fastened to the valve housing, the second bellows forming a second space at a position at a side of the valve assembly with respect to the power transmission member, the second space being isolated from the first space by the first bellows;
a first pipe communicating with the first space; and
a second pipe communicating with the second space,
wherein the valve head is configured to open and close a transfer path formed in the valve housing by transmitting the power to the valve assembly from the power transmission member according to a pressure ratio between working fluid supplied to the first space and the second space via the first pipe and the second pipe, respectively, and
the valve head has a Vickers hardness larger than a Vickers hardness of a valve seat of the transfer path to be in contact with the valve head, and a hardness difference therebetween is set to be about 200 Hv to about 300 Hv.

2. The control valve device of claim 1, wherein the Vickers hardness of the valve seat is set to be about 400 Hv to about 500 Hv.

3. The control valve device of claim 1, wherein the valve seat is a surface of a metal, to which stellite is attached.

4. The control valve device of claim 1, wherein the valve head is plated with a Ni-based alloy.

5. The control valve device of claim 1, wherein a portion of the valve head that is contacted with the transfer path has a tapered shape, and
a taper angle to a component perpendicular to a leading end surface of the valve head ranges from about 40° to about 80°.

6. The control valve device of claim 1, wherein a portion of the valve head that is contacted with the transfer path has a circular arc shape having a radius of curvature.

7. The control valve device of claim 1, wherein the valve seat has a tapered shape or a circular arc shape.

8. The control valve device of claim 1, wherein the control valve device is used at a temperature ranging from about 25° C. to about 500° C.

9. The control valve device of claim 1, wherein an inert gas is supplied into the first and second spaces as the working fluid.

10. The control valve device of claim 1, wherein a liquid is supplied into the first and second spaces as the working fluid.

11. The control valve device of claim 1, wherein an operating pressure for the control valve device ranges from about 0.2 MPa to about 0.6 MPa.

12. The control valve device of claim 1, wherein the control valve device is used in opening and closing the transfer path configured to transfer organic molecules for forming a film on a processing target object up to a vicinity of the processing target object.
